(19) United States
(12) Patent Application Publication
(10) Pub. No.: US 2021/0312540 A1
(43) Pub. Date: Oct. 7, 2021

(54) OFFER RECOMMENDATIONS FOR UNSUCCESFUL BUYERS

(71) Applicant: eBay Inc., San Jose, CA (US)

(72) Inventor: Vikas Singh, San Jose, CA (US)

(21) Appl. No.: 16/836,979

(22) Filed: Apr. 1, 2020

(51) Int. Cl. G06Q 30/08; G06Q 30/06

(52) U.S. Cl. CPC G06Q 30/08; G06Q 30/0629; G06Q 30/0619

(57) ABSTRACT

Disclosed are systems, methods, and non-transitory computer-readable media for offer recommendations for unsuccessful buyers. An offer recommendation system determines that an offer submitted for a listing posted to an online marketplace was unsuccessful. The offer recommendation system identifies a similar listing posted to the online marketplace and transmits a notification message to the seller that posted the similar listing. The notification message identifies the amount of the unsuccessful offer.

### TECHNICAL FIELD

An embodiment of the present subject matter relates generally to online marketplace services and, more specifically, to offer recommendations for unsuccessful buyers.

### BACKGROUND

Online marketplace services allow users to buy and sell items. For example, these services enable users to post listings for each item that the user wishes to sell, as well as view listings posted by other users. Users of the marketplace service may submit offers to purchase the listed items. For example, an online marketplace may offer a live auction that allows users to submit bids for a specified duration of time, after which the live auction ends. The user with the highest bid at the end auction wins the listed item, while the other users that bid on the item are unsuccessful in purchasing the item. In many cases, these unsuccessful users may have invested considerable time and effort attempting to purchase the listed item and may be discouraged from restarting the process with another listing. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for offering recommendations for unsuccessful buyers, according to some example embodiments.

FIG. 2. is a block diagram of an offer recommendation system, according to some example embodiments.

FIGS. 3A-3C show notification messages generated by an offer recommendation system, according to some example embodiments.

FIG. 4 is a flowchart showing a method of offering recommendations for unsuccessful buyers, according to certain example embodiments.

FIG. 5 is a flowchart showing a method of automatically generating an offer for an alternate item, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for providing offer recommendations to unsuccessful buyers. An offer recommendation system performs functionality that facilitates purchase of an alternate item by an unsuccessful buyer. An unsuccessful buyer is a user of an online marketplace that was unsuccessful in an attempt to purchase an item (‘primary item’) listed for sale on the online marketplace. For example, the unsuccessful buyer may have submitted an offer to purchase the primary item, which was rejected by the seller. Alternatively, the unsuccessful buyer may have submitted an offer to purchase the primary item but was outbid by another user that submitted a higher offer.

The offer recommendation system monitors usage of the online marketplace to identify unsuccessful buyers and aids in facilitating purchases of alternate items by the unsuccessful buyers. An alternate item is an item listed for sale on the online marketplace that is the same or similar to the primary item which the buyer was unsuccessful in purchasing. In response to identifying an unsuccessful buyer, the offer recommendation system identifies a set alternate items and transmits a notification message to the sellers of the alternate items. The notification message includes data related to the unsuccessful buyer's attempt at purchasing the primary item. For example, the notification message may identify the unsuccessful buyer, an account of the unsuccessful buyer, the primary item, the listing for the primary item, and/or an amount offered by the unsuccessful buyer for the primary item.

Providing sellers with the notification message encourages the sellers to communicate with the unsuccessful buyer regarding purchasing an alternate item listed by the sellers. For example, a seller may provide the unsuccessful buyer with an offer to purchase an alternate item that the unsuccessful buyer may simply accept to complete the purchase. Further, the seller may offer the alternate item to the unsuccessful buyer for the same amount offered by the unsuccessful buyer for the primary item. Providing the unsuccessful buyer with an offer to purchase an alternate item for the same amount the unsuccessful user offered for the primary increases that likelihood that the offer will be accepted by the unsuccessful user.

In some embodiments, the notification message provided to the sellers may enable the sellers to submit an offer to the unsuccessful buyer to purchase the alternate item. For example, the notification message may include text prompting the seller to provide an offer to the unsuccessful buyer to purchase the alternate item along with a user interface element, such as a button, which the seller may select to initiate the offer. The notification message may include a purchase amount to be offered to the unsuccessful buyer, which the seller may accept. For example, the purchase amount may be based on the amount offered by the unsuccessful buyer for the primary item. The notification message may also enable the seller to enter a purchase amount to offer to the unsuccessful buyer, such as by entering the purchase amount into a text field.

In some embodiments, the offer recommendation system may automatically generate and provide an unsuccessful buyer with an offer to purchase an alternate item listed to the online marketplace. Some sellers may have predefined offer acceptance configurations associated with their listings. The offer acceptance conditions dictate parameters under which an offer submitted for the listed item is authorized to be automatically accepted without further confirmation from the seller. For example, the offer acceptance configurations may define a minimum offer amount for an item that is authorized to be accepted. Accordingly, any offer received for the item that meets the minimum offer amount (e.g., is equal to or greater than the minimum offer amount) is authorized to be accepted.

The offer recommendation system may compare the amount offered by the unsuccessful buyer for the primary item to the minimum offer amounts designated with the alternate items. In the event that the amount offered by the unsuccessful buyer for the primary item meets the minimum offer amount designated to an alternate item, the offer recommendation system may automatically provide the unsuccessful buyer with an offer to purchase the alternate item. The purchase amount offered to the unsuccessful buyer may be the same as the amount offered by the unsuccessful buyer for the primary item. As a result, an unsuccessful buyer is automatically provided with an offer to purchase the alternate item for the same amount that the unsuccessful buyer offered to purchase the primary item.

The functionality of the offer recommendation system provides several technical improvements. For example, by facilitating purchase of an alternate item the offer recommendation system reduces overall resource usage of the underlying computing systems. Unsuccessful buyers and sellers are connected quickly, thereby reducing the lengthy periods of time buyers spend searching the online marketplace for similar items. Further, providing the sellers with an offer to purchase an alternate item for same amount offered by the buyer reduces the offer/acceptance process, thereby further reducing resource usage of the underlying computing systems. Similarly, automatically generating and providing offers to unsuccessful buyers may result in an almost instantaneous sale of the alternate item, which eliminates essentially all strain placed on the underlying computing systems by resource usage user associated with unsuccessful buyers.

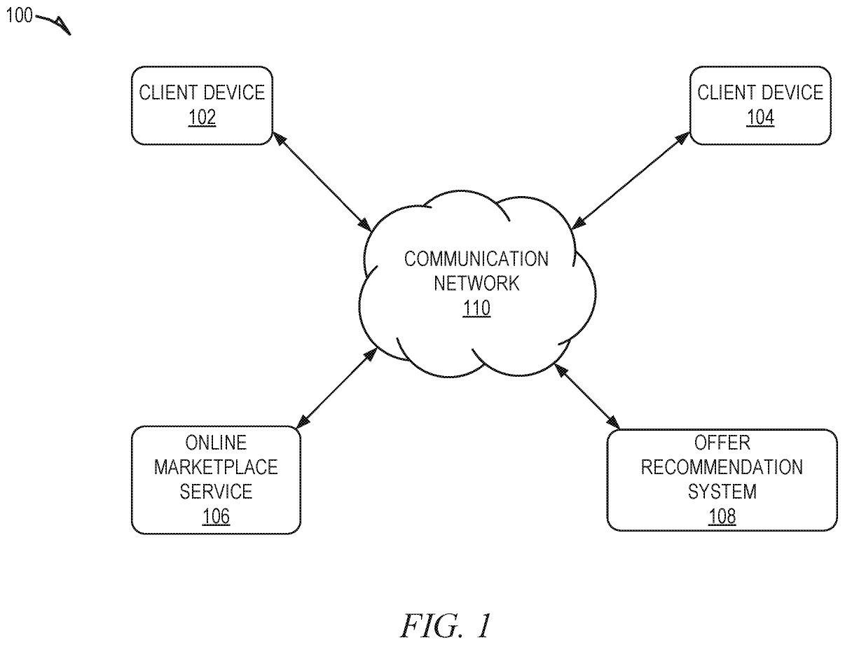

FIG. 1 shows a system 100 for offering recommendations for unsuccessful buyers, according to some example embodiments. As shown, multiple devices (i.e., client device 102, client device 104, online marketplace service 106, and offer recommendation system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

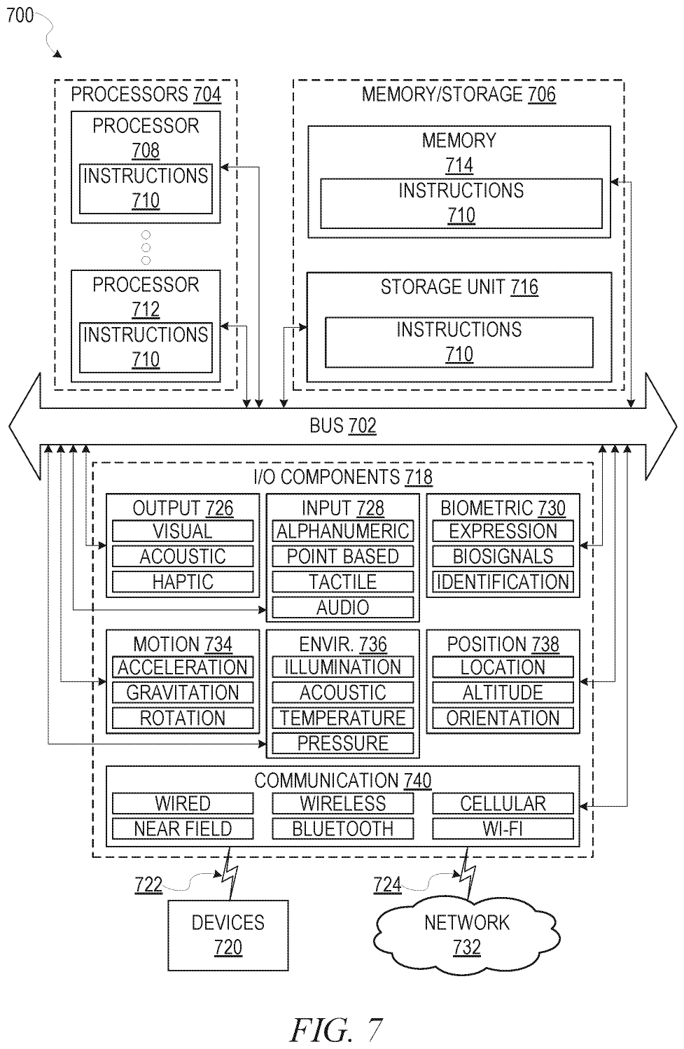

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online marketplace service 106 to utilize the services provided by the online marketplace service 106. The online marketplace service 106 provides an online marketplace to which users may post items for sale and purchase items posted for sale by other users. For example, the online marketplace service 106 may include listing for items being auctioned for sale and/or items listed for sale at a set price. Users communicate with and utilize the functionality of the online marketplace service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online marketplace service 106 may concurrently accept connections from and interact with any number of client devices 102, 104. The online marketplace service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online marketplace service 106 via a client-side application installed on the client devices 102 and 104. In some embodiments, the client-side application includes a component specific to the online marketplace service 106. For example, the component may be a stand-alone application, one or more application plug-ins, and/or a browser extension. However, the users may also interact with the online marketplace service 106 via a third-party application, such as a web browser, that resides on the client devices 102 and 104 and is configured to communicate with the online marketplace service 106. In either case, the client-side application presents a user interface (UI) for the user to interact with the online marketplace service 106. For example, the user interacts with the online marketplace service 106 via a client-side application integrated with the file system or via a webpage displayed using a web browser application.

The online marketplace service 106 is one or more computing devices configured to facilitate an online marketplace (e.g., EBAY, AMAZON, etc.) to which users may post items for sale and purchase items posted for sale by other users. For example, the online marketplace service 106 provides a user interface in which users may view item listings posted to the online marketplace service 106. Each item listing provides details for an item or items listed for sale. For example, the item listing may include an item description, images, sale price, current bid price, auction time remaining, etc.

The online marketplace service 106 may further provide functionality that enables a user to purchase and/or submit on offer to purchase an item. For example, the online marketplace service 106 may provide user interface elements (e.g., buttons, text fields, etc.) that a user may use to purchase an item, submit an offer, etc., as well as provide their financial (e.g., credit card number, bank account number) and personal information (e.g., shipping address, billing address, etc.) to complete the purchase.

To list an item for sale on the online marketplace, a user creates a user account with the online marketplace service 106. The user account may include the user's personal information (e.g., name, address, email address, phone number, etc.) and financial information (e.g., credit card information, bank account information, etc.). Once the user has created a user account, the user may then use their user account to utilize the functionality of the online marketplace service 106, including listing an item for sale on the online marketplace. The online marketplace service 106 provides users with a listing interface that enables a user to create a new listing as well as provide data for the listing. For example, the listing interface may include data fields that prompt the user to provide specified information for the listing, such as the sale price, description, etc. The listing interface may also include user interface elements, such as buttons, that enable the user to submit and/or post a completed listing. That is, the user may post the listing after the user has filled in the data fields included in the listing interface.

An item listed for sale on the online marketplace may be listed for sale at a set sale price and/or as an auction. An item listed for sale at a set sale price may be purchased for the sale price while the listing for the item is active. For example, a user can select to purchase the listed item in exchange for payment of the set sale price.

In contrast, an item listed as an auction allows users an opportunity to submits offers (e.g., bids) for a specified duration of time, after which the auction ends. The user that submitted the highest offer prior to the end of the auction wins the listed auction, meaning that the winning user's offer to purchase the item is accepted by the seller. As a result, the winning user agrees to pay the offered amount in exchange for the listed item.

An item may also be listed for both a set sale price and as an auction. For example, a seller may list an item as an auction and also designate a set sale price for the item. In this type of embodiments, the listing will function as an auction in that users are provided an opportunity to submits offers for a specified duration of time, after which the user that submitted the highest offer wins the auction. However, if a user selects to the purchase the item for the set sale price prior to the end of the auction, the auction is terminated, and the listed item is sold to the user for the set sale price.

In some embodiments, a user may submit an offer for an item that is listed for a set sale price. For example, a user may submit an offer that is lower than the set sale price, which a seller of the item may choose to either accept or deny. If the seller chooses to accept the user's offer, the user purchases the item from the seller for the offered amount.

Whether it be in relation to an item listed as an auction or an item listed for a set sale price, unsuccessful buyers that submit offers that are unsuccessful in purchasing the item (e.g., the offer is denied by the seller, a higher offer is submitted by another user) may become frustrated. For example, unsuccessful buyers often invest considerable time and effort searching for an item of interest, submitting offers, waiting for a response from the seller, and/or waiting for an auction to end. Investing a large amount of time and effort that results in an unsuccessful outcome may discourage unsuccessful buyers from restarting the purchasing process.

To alleviate this issue, the online marketplace service 106 utilizes the functionality of the offer recommendation system 108. The offer recommendation system 108 facilitates purchase of an alternate item by an unsuccessful buyer. Although the offer recommendation system 108 and the online marketplace service 106 are shown as two separate entities, this is just one possible embodiment and is not meant to be limiting. In some embodiments, the functionality of the offer recommendation system 108 may be integrated into the online marketplace service 106.

The offer recommendation system 108 monitors usage of the online marketplace to identify unsuccessful buyers and aids in facilitating purchases of alternate items by the unsuccessful buyers. An alternate item is an item listed for sale on the online marketplace that is the same or similar to the primary item which the unsuccessful buyer attempted to purchase. In response to identifying an unsuccessful buyer, the offer recommendation system 108 identifies a set alternate items and transmits a notification message to the sellers of the alternate items. The notification message may be any type of communication message, such as an email, text message, in-app message, and the like.

The notification message includes data related to the unsuccessful buyer's attempt at purchasing the primary item. For example, the notification message may identify the unsuccessful buyer, an account of the unsuccessful buyer, the primary item, the listing for the primary item, and/or an amount offered by the unsuccessful buyer to purchase the primary item.

Providing sellers with the notification message encourages the sellers to communicate with the unsuccessful buyer regarding purchasing an alternate item listed by the sellers. For example, a seller may provide the unsuccessful buyer with an offer to purchase an alternate item that the unsuccessful buyer may simply accept to complete the purchase. Further, the seller may offer the alternate item to the unsuccessful buyer for the same amount offered by the unsuccessful buyer for the primary item. Providing the unsuccessful buyer with an offer to purchase an alternate item for the same amount offered by the unsuccessful buyer for the primary increases that likelihood that the unsuccessful user will accept the offer.

In some embodiments, the notification message provided to the sellers may enable the sellers to submit an offer to the unsuccessful buyer to purchase the alternate item. For example, the notification message may include text prompting the seller to provide an offer to the unsuccessful buyer to purchase the alternate item, as well as a user interface element, such as a button, which the seller may select to initiate the offer. The notification message may include a purchase amount to be offered to the unsuccessful buyer. For example, the purchase amount may be based on the amount offered by the unsuccessful buyer for the primary item. The notification message may also enable the seller to enter a purchase amount to offer to the unsuccessful buyer, such as by entering the purchase amount into a text field.

In some embodiments, the offer recommendation system 108 may automatically generate and provide an unsuccessful buyer with an offer to purchase an alternate item listed to the online marketplace. Some sellers may have predefined offer acceptance configurations associated with their listings. The offer acceptance conditions dictate parameters under which an offer submitted for the item is authorized to be automatically without further confirmation from the seller. For example, the offer acceptance configurations may define a minimum offer amount for an item that is authorized to be accepted. Accordingly, any amount offered for the listed item that meets the minimum offer amount is authorized to be accepted.

The offer recommendation system 108 may compare the amount offered by the unsuccessful buyer for the primary item to the minimum offer amounts associated with the alternate listings. In the event that the amount offered by the unsuccessful buyer for the primary item meets the minimum offer amount associated with an alternate item, the offer recommendation system 108 may automatically provide the unsuccessful buyer with an offer to purchase the alternate item. The purchase amount offered to the unsuccessful buyer may be the same as the amount offered by the unsuccessful buyer for the primary item. As a result, an unsuccessful buyer is automatically provided with an offer to purchase an alternate item for the same amount that the unsuccessful buyer offered for the primary item.

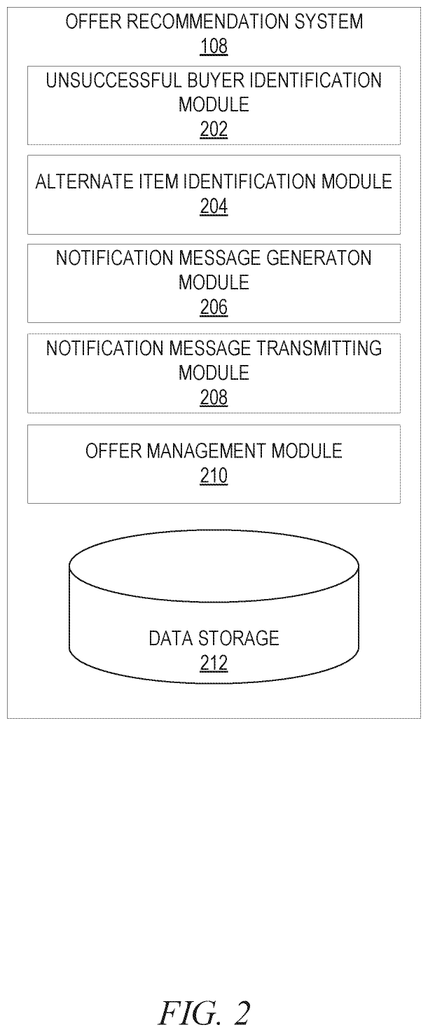

FIG. 2 is a block diagram of an offer recommendation system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the offer recommendation system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the offer recommendation system 108 and the online marketplace service 106.

As shown, the offer recommendation system 108 includes an unsuccessful buyer identification module 202, an alternate item identification module 204, a notification message generation module 206, a notification message transmitting module 208, an offer management module 210, and a data storage 212.

The unsuccessful buyer identification module 202 identifies unsuccessful buyers. For example, the unsuccessful buyer identification module 202 monitors activity data associated with the online marketplace for submitted offers that were unsuccessful in purchasing an item listed for sale on the online marketplace. The activity data describes actions performed in relation to the online marketplace, such as data identifying listings posted, offers submitted, offers rejected, auctions ending, items being sold, and the like. In some embodiments, the unsuccessful buyer identification module 202 may communicate with the online marketplace service 106 to access the activity data from the online marketplace service 106. Alternatively, the unsuccessful buyer identification module 202 may access the activity data from the data storage 212, such as in embodiments in which the functionality of the offer recommendation system 108 is integrated into the online marketplace service 106.

The unsuccessful buyer identification module 202 provides data associated with an identified unsuccessful buyer to the other modules of the offer recommendation system 108. For example, the unsuccessful buyer identification module 202 may provide the other modules with data describing the primary item (e.g., an item that the unsuccessful buyer was unsuccessful in purchasing), the listing associated with the primary item, data describing the unsuccessful buyer, such as a unique identifier associated with the unsuccessful buyer and/or an account of the unsuccessful buyer, and the like.

The alternate item identification module 204 identifies alternate items based on a primary item. An alternate item is an item listed for sale on the online marketplace that is the same or similar to the primary item which the buyer was unsuccessful in purchasing. The alternate item identification module 204 may identify the alternate items based on listing data associated with the online marketplace. The listing data describes items listed for sale on the online marketplace, including a description of the listed items, sale price, and the like. The alternate item identification module 204 may access the listing data from the online marketplace service 106 and/or the data storage 212.

The alternate item identification module 204 uses the listing data to identify listed items that are the same or similar to the primary item. For example, the alternate item identification module 204 may use data identifying the primary item (e.g., item identifier, item description, listing title, etc.), to search the listing data for other listed items that are the same or similar to the primary item. For example, the alternate item identification module 204 may search for listed items that have the same or similar item identifier, item description, listing title, and the like.

The alternate item identification module 204 may select a subset or all of the identified items as being alternate items for the primary item. The alternate item identification module 204 may provide the other modules of the offer recommendation system 108 with data associated with the alternate items, such as data identifying the sellers of the alternate items, the listings for the alternate items, and the like.

The notification message generation module 206 generates notification messages to be transmitted to the sellers of the alternate items and/or the unsuccessful buyers. The notification messages are transmitted to facilitate a purchase of an alternate item by the unsuccessful buyer. For example, a notification message generated for a seller of an alternate item may include data indicating that an unsuccessful buyer was unable to purchase a primary item that is the same or similar to an item listed by the seller. The notification message may also provide the seller with an amount offered by the unsuccessful buyer to purchase the primary item. Providing a seller with the notification message encourages the sellers to communicate with the unsuccessful buyer regarding purchasing an alternate item listed by the sellers. For example, a seller may provide the unsuccessful buyer with an offer to purchase an alternate item that the unsuccessful buyer may simply accept to complete the purchase.

In some embodiments, the notification message may enable the sellers to submit an offer to the unsuccessful buyer to purchase the alternate item. For example, the notification message may include text prompting the seller to provide an offer to the unsuccessful buyer to purchase the alternate item along with a user interface element, such as a button, which the seller may select to initiate the offer. The notification message may include a purchase amount to be offered to the unsuccessful buyer, which the seller may accept. For example, the purchase amount may be based on the amount offered by the unsuccessful buyer for the primary item. The notification message may also enable the seller to enter a purchase amount to offer to the unsuccessful buyer, such as by entering the purchase amount into a text field.

The notification message generation module 206 may also generate notification messages for an unsuccessful buyer. For example, the notification message may include data identifying alternate items listed to the online marketplace as well as enable the unsuccessful buyer to access listings for the alternate items. For example, the notification message may include user interface elements, such as a buttons or links, that the unsuccessful buyer may select to access the listings for the alternate items included in the notification. The notification messages encourage the unsuccessful buyer to view and potentially purchase an alternate item listed to the online marketplace.

In some embodiments, the notification message enables the unsuccessful buyer to submit an offer for an alternate item listed in the notification message. For example, the notification message may include user interface elements such as a text field and buttons, that allow the unsuccessful user to submit an amount to offer for the alternate item and submit an offer for the alternate item. The unsuccessful buyer may therefore quickly submit an offer to purchase an alternate item directly from the notification message.

The notification message transmitting module 208 transmits notifications messages to their designated recipients. For example, the notification message transmitting module 208 may transmit notification messages to unsuccessful buyers and/or sellers of alternate items. A notification message may be transmitted using any of a variety of communication channels, such email, text messaging, direct messaging, in-app messaging, and the like.

The offer management module 210 provides functionality related to automatically generating offers. For example, the offer management module 210 uses an amount offered by the unsuccessful buyer and offer acceptance configurations associated with the alternate items to determine whether to provide the unsuccessful buyer with an offer to purchase an alternate item.

Some items listed on the online marketplace may be associated with offer acceptance configurations established by sellers of the items. The offer acceptance conditions dictate parameters under which an offer submitted for the item is authorized to be automatically accepted without further confirmation from the seller. For example, the offer acceptance configurations may define a minimum offer amount for an item that is authorized to be automatically accepted. Accordingly, any offer received for the item that meets the minimum offer amount is authorized to be accepted by the online marketplace service 106 without receiving any additional confirmation from the seller.

The offer management module 210 uses the amount offered by the unsuccessful buyer and the offer acceptance configurations associated with an alternate item to determine whether an offer to purchase the alternate item can be automatically provided to the unsuccessful buyer. For example, the offer management module 210 compares the amount offered by the unsuccessful buyer to the minimum offer amount and determines to provide the unsuccessful buyer with an offer to purchase the alternate item if the amount offered by the unsuccessful buyer meets (e.g., is equal to or greater than) the minimum offer amount.

The offer management module 210 may notify the notification message generation module 206 to generate a notification message for the unsuccessful buyer that includes an offer to purchase the alternate item. The offer management module 210 may select a purchase amount for the offer based on the amount offered by the unsuccessful buyer for the primary item. For example, the purchase amount offered to the unsuccessful buyer may be the same as the amount offered by the unsuccessful buyer for the primary item. As a result, an unsuccessful buyer is automatically provided with an offer to purchase the alternate item for the same amount that the unsuccessful buyer offered for the primary amount.

In some embodiments, the offer management module 210 may determine to provide the unsuccessful buyer with an offer even if the amount offered by the unsuccessful offer does not meet the minimum offer amount. For example, in situations when the offer amount is below, but within a threshold amount of the minimum offer amount, the offer management module 210 may determine to transmit an offer to the unsuccessful buyer. In this type of situation, the purchase amount offered to the unsuccessful buyer to purchase the alternate item may be the minimum purchase amount rather than the amount the unsuccessful buyer had offered for the primary item.

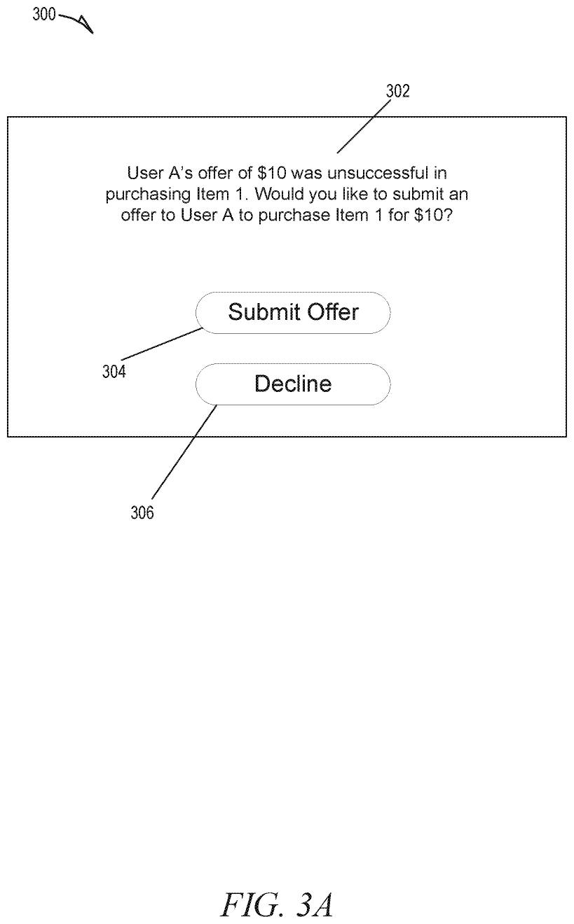

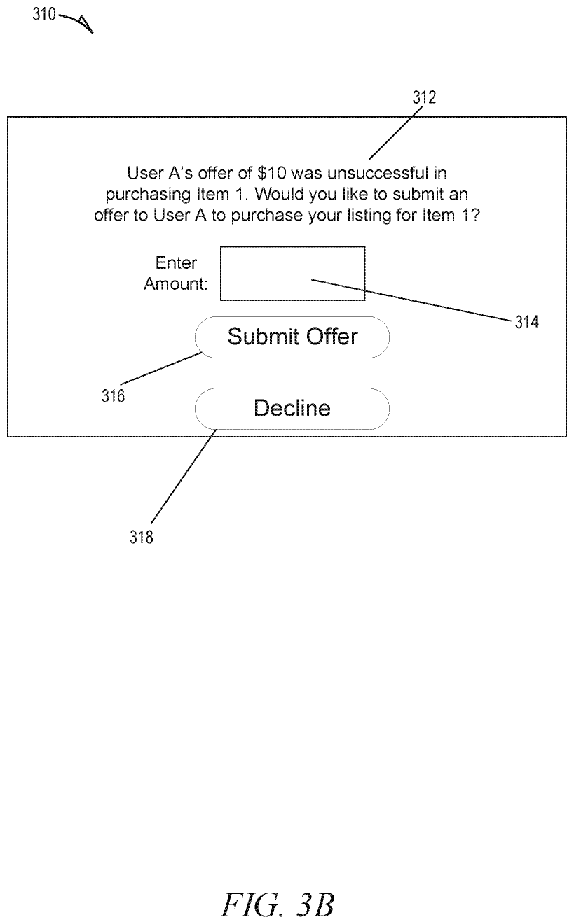

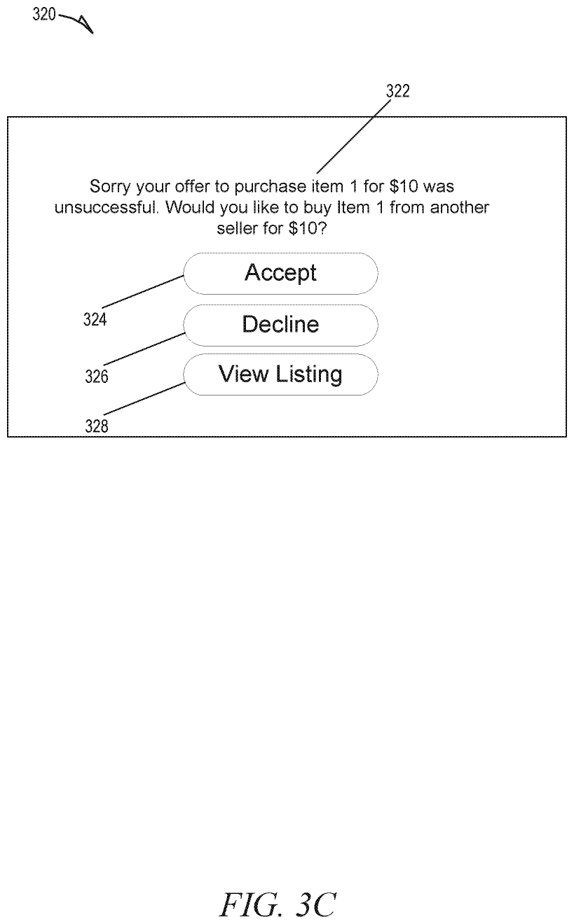

FIGS. 3A-3C show notification messages generated by an offer recommendation system 108, according to some example embodiments. FIG. 3A shows a notification message 300 transmitted to a seller of an alternate item. As shown, the notification message 300 includes text 302 that notifies the seller that User A is an unsuccessful buyer that submitted an offer of ten dollars to purchase Item 1. The text 302 further prompts the user regarding submitting User A with an offer to purchase Item 1 from the seller for ten dollars. For example, the seller may have a listing posted to the online marketplace that offers Item 1 for sale.

The notification message 300 further includes a submit offer button 304 and a decline button 306. The submit offer button 304 enables the seller to submit an offer to User A to purchase Item 1 from the seller for ten dollars. For example, the seller may select the submit offer button 304 to cause the offer to be submitted to User A. The decline button 306 enables the seller to decline to submit an offer to User A. For example. the seller may select the decline button 306 to decline submitting an offer to User 1.

The notification message 310 shown in FIG. 3B also includes text 312 that notifies the seller that User A is an unsuccessful buyer that submitted an offer of ten dollars to purchase Item 1. The text 312 prompts the seller to provide the unsuccessful buyer (i.e., User A) with an offer to purchase Item 1, however the purchase price to be offered is not included in the text 312, as it was in the text 302 shown in FIG. 3A. Rather, the seller can submit an offered amount of his/her choice. For example, the seller may use the text field 314 to enter an amount to offer to User A. The seller may use the offered amount of ten dollars that is identified in the text 312 as a guide when selecting an amount to offer User A. For example, the seller may choose to offer the same amount of ten dollars that User A had offered for Item 1. Alternatively, the seller may choose a higher or lower amount than User A had offered, such as eleven dollars or nine dollars.

The notification message 310 includes a submit offer button 316 and a decline button 318. The submit offer button 316 enables the seller to submit an offer to User A to purchase Item 1 from the seller for the offer amount entered into the text field 314. For example, the seller may select the submit offer button 316 to cause the offer to be submitted to User A. The decline button 318 enables the seller to decline to submit an offer to User A. For example, the seller may select the decline button 318 to decline submitting an offer to User 1.

FIG. 3C shows a notification message 320 that is presented to an unsuccessful buyer. As shown, the notification message 300 includes text 322 notifying the unsuccessful buyer that Item 1 is available for purchase from another seller. The text also presents the unsuccessful buyer with an offer to purchase Item 1 for ten dollars. The notification message 320 may have been sent to the unsuccessful buyer as a result of the seller selecting to provide the unsuccessful buyer with an offer or sent automatically based on offer acceptance configurations provided by the seller.

The notification message 320 includes an accept button 324 and a decline button 326, which enable the unsuccessful buyer to either accept or deny the offer presented by the notification message 320. For example, the unsuccessful buyer may select the accept button 324 to accept the offer or select the decline button 326 to decline the offer.

The notification message 320 also includes a view listing button 328 that enables the unsuccessful buyer to view the listing for the alternate item that is posted to the online marketplace. For example, selection of the view listing button 328 causes the unsuccessful buyer to be presented with the listing for the alternate item. This allows the unsuccessful buyer with an opportunity to examine the alternate item in greater detail, which may be particularly helpful when purchasing used items rather than new items. For example, used items may be in offered for sale in varying conditions. Accordingly, the unsuccessful buyer may wish to view the alternate item prior to purchase to ensure that it is in acceptable condition for the unsuccessful buyer.

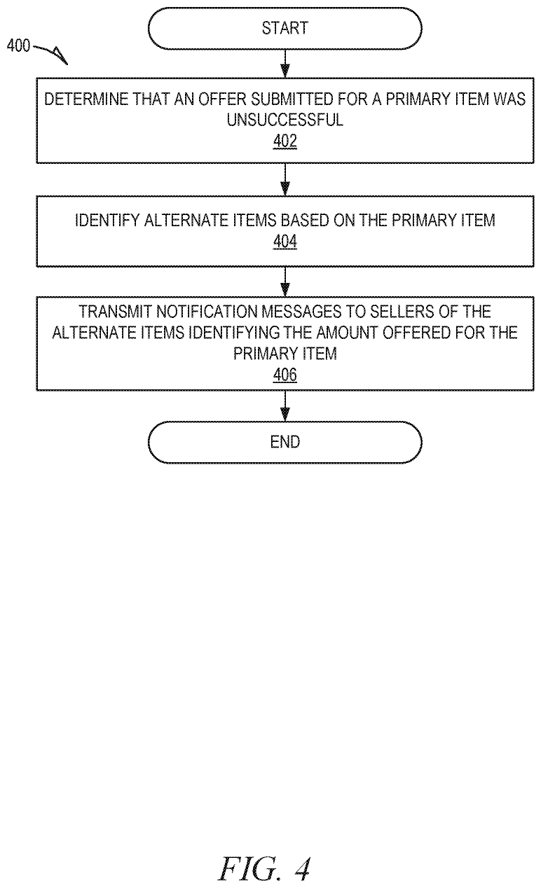

FIG. 4 is a flowchart showing a method 400 of offering recommendations for unsuccessful buyers, according to certain example embodiments. The method 400 may be embodied in computer readable instructions for execution by one or more processors such that the operations of the method 400 may be performed in part or in whole by the offer recommendation system 108; accordingly, the method 400 is described below by way of example with reference thereto. However, it shall be appreciated that at least some of the operations of the method 400 may be deployed on various other hardware configurations and the method 400 is not intended to be limited to the offer recommendation system 108.

At operation 402, the unsuccessful buyer identification module 202 determines that an offer submitted for a primary item was unsuccessful in purchasing the primary item. For example, the unsuccessful buyer identification module 202 monitors activity data associated with the online marketplace for submitted offers that were unsuccessful in purchasing an item listed for sale on the online marketplace. The activity data describes actions performed in relation to the online marketplace, such as data identifying listings posted, offers submitted, offers rejected, auctions ending, items being sold, and the like. In some embodiments, the unsuccessful buyer identification module 202 may communicate with the online marketplace service 106 to access the activity data from the online marketplace service 106. Alternatively, the unsuccessful buyer identification module 202 may access the activity data from the data storage 212, such as in embodiments in which the functionality of the offer recommendation system 108 is integrated into the online marketplace service 106.

At operation 404, the alternate item identification module 204 identifies alternate items based on the primary item. An alternate item is an item listed for sale on the online marketplace that is the same or similar to the primary item which the buyer was unsuccessful in purchasing. The alternate item identification module 204 may identify the alternate items based on listing data associated with the online marketplace. The listing data describes items listed for sale on the online marketplace, including a description of the listed items, sale price, and the like. The alternate item identification module 204 may access the listing data from the online marketplace service 106 and/or the data storage 212.

The alternate item identification module 204 uses the listing data to identify other listed items that are the same or similar to the primary item. For example, the alternate item identification module 204 may use data identifying the primary item (e.g., item identifier, item description, listing title, etc.), to search the listing data for other listed items that have the same item identifier, item description, listing title, and the like. The alternate item identification module 204 may select a subset or all of the identified items as being alternate items for the primary item.

At operation 406, the notification transmitting module 208 transmits notification messages to sellers of the alternate items identifying the amount offered for the primary item. The notification message generation module 206 generates the notification messages to be transmitted to the sellers of the alternate items. For example, the notification message generated for the sellers may include data indicating that the unsuccessful buyer was unable to purchase the primary item that is the same or similar to the alternate item listed by the seller. The notification message may also provide the seller with the amount offered by the unsuccessful buyer to purchase the primary item.

Once the notification messages have been generated, the notification transmitting module 208 transmits the notification messages to the sellers of the alternate items. For example, the notification message transmitting module 208 may transmit the notification messages using any of a variety of communication channels, such email, text messaging, direct messaging, in-app messaging, and the like.

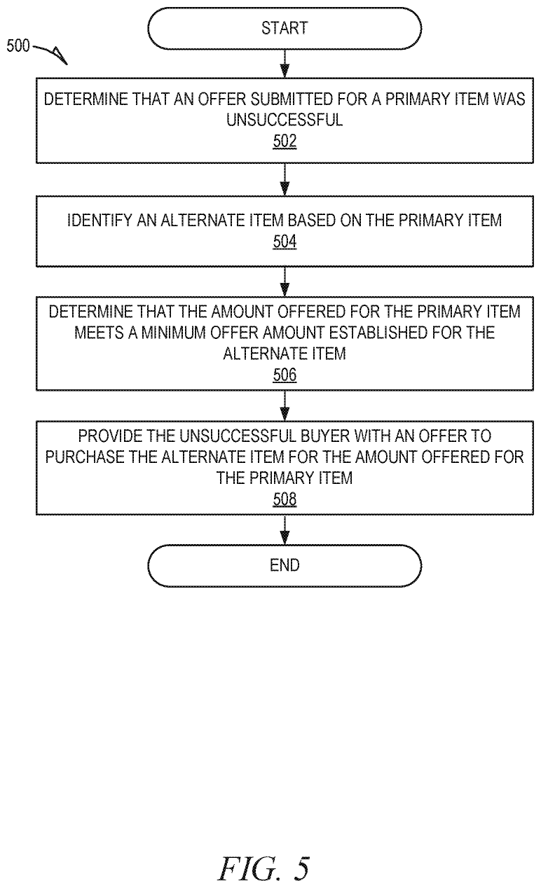

FIG. 5 is a flowchart showing a method 500 of automatically generating an offer for an alternate item, according to certain example embodiments. The method 500 may be embodied in computer readable instructions for execution by one or more processors such that the operations of the method 500 may be performed in part or in whole by the offer recommendation system 108; accordingly, the method 500 is described below by way of example with reference thereto. However, it shall be appreciated that at least some of the operations of the method 500 may be deployed on various other hardware configurations and the method 500 is not intended to be limited to the offer recommendation system 108.

At operation 502, the unsuccessful buyer identification module 202 determines that an offer submitted for a primary item was unsuccessful. For example, the unsuccessful buyer identification module 202 monitors activity data associated with the online marketplace for submitted offers that were unsuccessful in purchasing an item listed for sale on the online marketplace. The activity data describes actions performed in relation to the online marketplace, such as data identifying listings posted, offers submitted, offers rejected, auctions ending, items being sold, and the like. In some embodiments, the unsuccessful buyer identification module 202 may communicate with the online marketplace service 106 to access the activity data from the online marketplace service 106. Alternatively, the unsuccessful buyer identification module 202 may access the activity data from the data storage 212, such as in embodiments in which the functionality of the offer recommendation system 108 is integrated into the online marketplace service 106.

At operation 504, the alternate item identification module 204 identifies an alternate item based on the primary item. An alternate item is an item listed for sale on the online marketplace that is the same or similar to the primary item. The alternate item identification module 204 may identify the alternate item based on listing data associated with the online marketplace. The listing data described items listed to the online marketplace, including a description of the listed items, sale price, and the like. The alternate item identification module 204 may access the listing data from the online marketplace service 106 and/or the data storage 212.

The alternate item identification module 204 uses the listing data to identify a listed item that is the same or similar to the primary item. For example, the alternate item identification module 204 may use data identifying the primary item (e.g., item identifier, item description, listing title, etc.), to search the listing data for another listed item that is the same or similar to the primary item, such as another item that is associated with the same or similar item identifier, item description and/or listing title.

At operation 506, the offer management module 210 determines that the amount offered for the primary item meets a minimum offer amount established for the alternate item. Some items listed on the online marketplace may be associated with offer acceptance configurations established by sellers of the items. The offer acceptance conditions dictate parameters under which an offer submitted for the item is authorized to be automatically accepted without further confirmation from the seller. For example, the offer acceptance configurations may define a minimum offer amount for an item that is authorized to be automatically accepted.

The offer management module 210 uses the amount offered by the unsuccessful buyer and the offer acceptance configurations associated with an alternate item to determine whether an offer to purchase the alternate item can be automatically provided to the unsuccessful buyer. For example, the offer management module 210 compares the amount offered by the unsuccessful buyer to the minimum offer amount and determines to provide the unsuccessful buyer with an offer to purchase the alternate item if the amount offered by the unsuccessful buyer meets (e.g., is equal to or greater than) the minimum offer amount.

At operation 508, the notification message transmitting module 208 provides the unsuccessful buyer with an offer to purchase the alternate item for the amount offered for the primary item. For example, the notification message transmitting module 208 may transmit the notification message to the unsuccessful buyers using any of a variety of communication channels, such email, text messaging, direct messaging, in-app messaging, and the like.

### Software Architecture

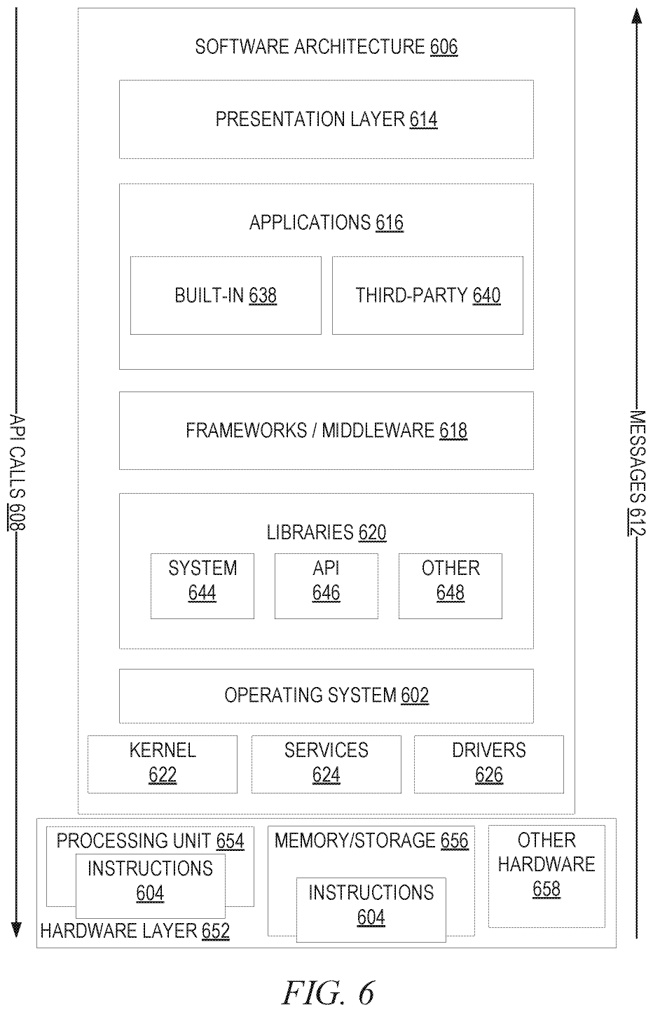

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke Application Programming Interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and UO components 718, which may be configured to communicate with each other such as via a bus 702. The memory/storage 706 may include a memory 714, such as a main memory, or other memory storage, and a storage unit 716, both accessible to the processors 704 (e.g., processors 708, 712) such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The UO components 718 may include a wide variety of components to receive input, provide output, produce output, transmit information, exchange information, capture measurements, and so on. The specific UO components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 704 (sometimes referred to as “cores”) that may execute instructions 710 contemporaneously.

What is claimed is:

1. A method comprising:
determining that an offer submitted for a first listing for an item was unsuccessful, the first listing being posted to an online marketplace, the offer being for a first amount and having been submitted by a first user associated with a first account of the online marketplace;
identifying at least a second listing posted to the online marketplace that is similar to the first listing, the second listing having been posted by a second user associated with a second account of the online marketplace; and
transmitting a notification message to the second user associated with the second account, the notification message identifying the first amount of the offer submitted by the first user associated with the first account.

2. The method of claim 1, further comprising:
transmitting a second notification message to the first user associated with the first account, the message identifying the second listing and enabling submission of a subsequent offer for the second listing; and
receiving an input indicating that the user associated with the first account has selected to submit the offer for the second listing, the second notification message transmitted to the user of the second account being the subsequent offer.

3. The method of claim 1, further comprising:
transmitting a second notification message to a third user associated with a third account that posted a third listing identified as being similar to the first listing, the second notification message identifying the first amount of the offer submitted by the first user associated with the first account.

4. The method of claim 1, further comprising:
determining, based on offer acceptance conditions associated with the second listing, that the first amount is greater than a minimum offer amount identified by the offer acceptance conditions as being acceptable to automatically accepted for the second listing; and
transmitting a subsequent offer to the first account, the subsequent offer being to purchase an item offered by the second listing for the first amount.

5. The method of claim 1, further comprising:
determining, based on offer acceptance conditions associated with the second account, that the first amount is within a threshold amount of a minimum offer amount identified by the offer acceptance conditions as being acceptable to automatically accepted for the second listing; and
transmitting a subsequent offer to the first account, the subsequent offer being to purchase an item offered by the second listing for the minimum offer amount.

6. The method of claim 1, wherein the notification message enables the user associated with the second account to submit a subsequent offer to the first user associated with the first account to purchase an item offered by the second listing, an amount included in the subsequent offer being based on the first amount.

7. The method of claim 1, wherein the offer submitted for the first listing corresponds to a bid made during an online auction.

8. A system comprising:
one or more computer processors; and
one or more computer-readable mediums storing instructions that, when executed by the one or more computer processors, cause the system to perform operations comprising:
determining that an offer submitted for a first listing for an item was unsuccessful, the first listing being posted to an online marketplace, the offer being for a first amount and having been submitted by a first user associated with a first account of the online marketplace;
identifying at least a second listing posted to the online marketplace that is similar to the first listing, the second listing having been posted by a second user associated with a second account of the online marketplace; and
transmitting a notification message to the second user associated with the second account, the notification message identifying the first amount of the offer submitted by the first user associated with the first account.

9. The system of claim 8, the operations further comprising:
transmitting a second notification message to the first user associated with the first account, the message identifying the second listing and enabling submission of a subsequent offer for the second listing; and
receiving an input indicating that the user associated with the first account has selected to submit the offer for the second listing, the second notification message transmitted to the user of the second account being the subsequent offer.

10. The system of claim 8, the operations further comprising:
transmitting a second notification message to a third user associated with a third account that posted a third listing identified as being similar to the first listing, the second notification message identifying the first amount of the offer submitted by the first user associated with the first account.

11. The system of claim 8, the operations further comprising:
determining, based on offer acceptance conditions associated with the second listing, that the first amount is greater than a minimum offer amount identified by the offer acceptance conditions as being acceptable to automatically accepted for the second listing; and
transmitting a subsequent offer to the first account, the subsequent offer being to purchase an item offered by the second listing for the first amount.

12. The system of claim 8, the operations further comprising:
determining, based on offer acceptance conditions associated with the second account, that the first amount is within a threshold amount of a minimum offer amount identified by the offer acceptance conditions as being acceptable to automatically accepted for the second listing; and
transmitting a subsequent offer to the first account, the subsequent offer being to purchase an item offered by the second listing for the minimum offer amount.

13. The system of claim 8, wherein the notification message enables the user associated with the second account to submit a subsequent offer to the first user associated with the first account to purchase an item offered by the second listing, an amount included in the subsequent offer being based on the first amount.

14. The system of claim 8, wherein the offer submitted for the first listing corresponds to a bid made during an online auction.

15. A machine-readable medium storing instructions that, when executed by one or more computing devices, cause the one or more computing devices to perform operations comprising:
determining that an offer submitted for a first listing for an item was unsuccessful, the first listing being posted to an online marketplace, the offer being for a first amount and having been submitted by a first user associated with a first account of the online marketplace;
identifying at least a second listing posted to the online marketplace that is similar to the first listing, the second listing having been posted by a second user associated with a second account of the online marketplace; and
transmitting a notification message to the second user associated with the second account, the notification message identifying the first amount of the offer submitted by the first user associated with the first account.

16. The machine-readable medium of claim 15, the operations further comprising:
transmitting a second notification message to the first user associated with the first account, the message identifying the second listing and enabling submission of a subsequent offer for the second listing; and
receiving an input indicating that the user associated with the first account has selected to submit the offer for the second listing, the second notification message transmitted to the user of the second account being the subsequent offer.

17. The machine-readable medium of claim 15, the operations further comprising:
transmitting a second notification message to a third user associated with a third account that posted a third listing identified as being similar to the first listing, the second notification message identifying the first amount of the offer submitted by the first user associated with the first account.

18. The machine-readable medium of claim 15, the operations further comprising:
determining, based on offer acceptance conditions associated with the second listing, that the first amount is greater than a minimum offer amount identified by the offer acceptance conditions as being acceptable to automatically accepted for the second listing; and
transmitting a subsequent offer to the first account, the subsequent offer being to purchase an item offered by the second listing for the first amount.

19. The machine-readable medium of claim 15, the operations further comprising:
determining, based on offer acceptance conditions associated with the second account, that the first amount is within a threshold amount of a minimum offer amount identified by the offer acceptance conditions as being acceptable to automatically accepted for the second listing; and
transmitting a subsequent offer to the first account, the subsequent offer being to purchase an item offered by the second listing for the minimum offer amount.

20. The machine-readable medium of claim 15, wherein the notification message enables the user associated with the second account to submit a subsequent offer to the first user associated with the first account to purchase an item offered by the second listing, an amount included in the subsequent offer being based on the first amount.
